(19) United States
(12) Patent Application Publication
(10) Pub. No.: US 2003/0007320 A1
(43) Pub. Date: Jan. 9, 2003

(54) Portable computer with extensible cartridges

(76) Inventors: David Yan, Moscow (RU); Igor Tsimokh, Moscow Region (RU); Sergey Chistyunin, Moscow Region (RU); Andrew Konovalov, Moscow Region (RU); Vasily Vinogradov, Moscow (RU); Ilia Golubev, Moscow (RU)

Correspondence Address: BAKER & MCKENZIE, 805 THIRD AVENUE, NEW YORK, NY, 10022, US

(21) Appl. No.: 09/901,387

(22) Filed: Jul. 9, 2001

(51) Int. Cl. H02B 1/00

(52) U.S. Cl. 361/600

(57) ABSTRACT

A portable device that includes a microcomputer having a housing with an operating system, a screen and a keypad with at least control keys. The portable device includes a connector socket for connecting a separate cartridge to interface the program on the cartridge to the operating system. The cartridge housing is made with an additional connector for setting an additional cartridge into it. When the additional cartridge is connected, applications on the additional cartridge may also be run by the microcomputer via the first cartridge without having to disconnect the first cartridge.

### TECHNICAL FIELD OF THE INVENTION

The present invention relates generally to electronics, and in particular, to a portable electronic game device that can connect more than one game cartridge at a time.

### BACKGROUND OF THE INVENTION

A known portable computer device contains a separate microcomputer with an operating system within a housing, a screen, and a keyboard with control keys. The housing has a connector socket that electrically connects a cartridge containing software so that the software can be run by the operating system. An example of such portable device is the Game Boy™ by Nintendo®.

A shortcoming of this device is that it only allows one cartridge to be connected and used at any one time. To change the software application, or switch to a different game that resides on a separate cartridge, it is necessary to remove one cartridge and replace it with another one. Thus, this device does not allow several applications on separate cartridges to run at the same time on the portable device.

Although portable devices may be capable of running multiple tasks simultaneously, e.g., by utilizing multi-tasking operating systems, because existing portable devices can only connect to one cartridge at a time, no two programs contained in separate cartridges can be run simultaneously.

Further, even if it is not necessary to run programs from separate cartridges at the same time, a user must disconnect one cartridge and connect another when running different programs from separate cartridges.

### SUMMARY OF THE INVENTION

To overcome the shortcomings of prior devices, present invention is a portable computer that can connect to more than one cartridge at one time. The connection may be accomplished by any one or more of parallel, serial, and parallel-serial connections.

The portable computer device of the present invention includes a microcomputer made as a separate module. The microcomputer typically is encased in a housing of a given shape with a screen and a keypad with at least control keys. Additional components may also be included. The microcomputer has a processor that runs an operating system. The housing of the microcomputer has a connector socket for directly setting and electrically connecting a separate cartridge module having software application. The cartridge may also be a separate peripheral device which has its own software application and has a housing with a connector for setting it into the socket on the microcomputer housing. The microcomputer communicates to the cartridge via the connector socket. The microcomputer then is able to run the software application residing on the cartridge under the microcomputer's operating system.

Cartridge housing may also include an additional connector for directly setting into it an additional cartridge. The additional cartridge, e.g., is also a separate module and has separate software, or it may be a separate peripheral device having its own program application that can run when the first cartridge is set into the connector socket of the microcomputer. The additional connector may be shaped like the connector socket on the microcomputer housing for electrically connecting to the additional cartridge and running its software under the operating system by means of the first cartridge.

The additional cartridge housing may include another additional connector for directly setting into it the next additional cartridge which is made as a separate module and has a separate software. The additional cartridge may also be a separate peripheral device having its own software application. The second additional connector is shaped similar to the connector socket on the microcomputer housing for electrically connecting the cartridge so that the programs on the cartridge can run under the microcomputer's operating system.

The microcomputer housing may also include at least one additional connector socket for directly setting and electrically connecting an additional cartridge. The additional cartridge may be a separate module and have separate software, or it may be a separate peripheral device which has its own software application. The separate peripheral device may include a housing with a connector for setting into the microcomputer socket to connect the software application to run under the microcomputer's operating system.

A cartridge housing may include another additional connector for directly setting into it an additional cartridge which is made as a separate module and has a separate software. The additional cartridge may be a separate peripheral device having its own software application. The second additional connector is, e.g., shaped like the contact socket on the microcomputer housing.

A cartridge housing may also be made parallelepiped-shaped such that connectors are placed on its sides to make it possible to set other cartridges, which are placed on the lateral face of the first cartridge housing and/or perpendicularly to the lateral face of the first cartridge housing. Parallelepiped refers to geometric figure formed of three pairs of parallel plain sides, such as a cube or a box.

The cartridge housings may have equal or different thickness. Cartridges may have equal dimensions, in height, width or length. Alternatively, the housing of at least one cartridge may have dimensions, i.e., height, width, and length, different from those of at least one other cartridges.

Further features and advantages of the present invention as well as the structure and operation of various embodiments of the present invention are described in detail below with reference to the accompanying drawings. In the drawings, like reference numbers indicate identical or functionally similar elements.

### BRIEF DESCRIPTION OF THE DRAWINGS

Preferred embodiments of the present invention will now be described, by way of example only, with reference to the accompanying drawings in which:

FIG. 1 shows general view of the microcomputer module in one embodiment;

FIGS. 2, 3, and 4 show a cartridge in three different embodiments of the present invention;

FIG. 5 shows a block of serially connected cartridges shown on FIG. 2;

FIG. 6 shows a block of serially connected cartridges with different dimensions;

FIG. 7 shows general view of the computer device with microcomputer shown on FIG. 1 and a block of parallel cartridges;

FIG. 8 shows general view of the microcomputer module in one embodiment;

FIG. 9 shows general view of the computer device with microcomputer shown on FIG. 8 and a block of cartridges serially set into one connector socket;

FIG. 10 shows general view of the computer device with microcomputer shown on FIG. 8 and cartridges set into two connector sockets;

FIG. 11 shows plane layout of the computer device with cartridges;

FIG. 12 is a general view of the computer device with microcomputer and plane cartridges being set in one embodiment; and

FIG. 13 is a general view of the computer device with microcomputer and plane cartridges set.

### DETAILED DESCRIPTION OF THE INVENTION

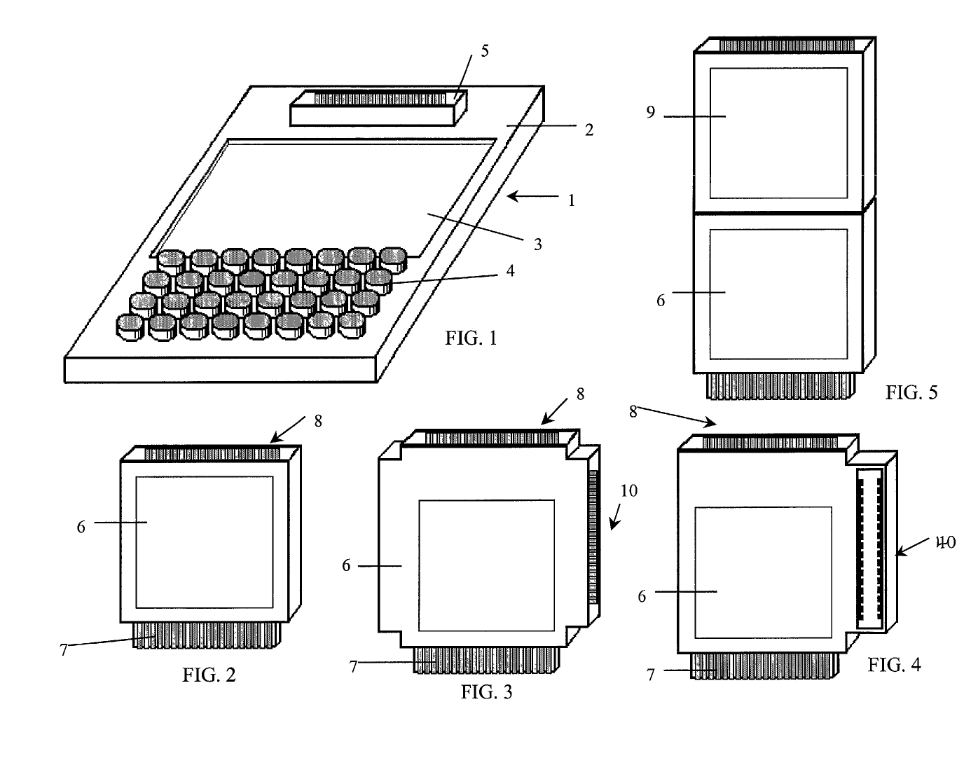

FIG. 1 shows a general view of the microcomputer module in one embodiment. The portable computer device of the present invention is a modular device built from attaching to the basic module additional cartridges joined to one another. The basic module may be a microcomputer or a minicomputer 1 shown in FIG. 1. The microcomputer 1 is an independent functional electronic computer with a given shape housing 2, a built-in or attached to the processor system screen 3, a built-in or attached to the processor system alphanumeric keypad 4. The microcomputer 1 is equipped with an appropriate software including an operating system to run various software applications. Such microcomputer or minicomputers are well known.

The micro or minicomputer housing 2 includes a connector socket 5 for setting a cartridge. An example of a cartridge 6 is shown in FIG. 2. The cartridge 6 may be directly set and electrically connected to the connector socket 5 on the microcomputer housing 2. As shown in FIG. 2, the cartridge 6 is made as a separate module and has a separate software application. The cartridge 6 may also be a separate peripheral device which has its own software application. Cartridge 6 (FIG. 2) has a given shape housing, e.g., parallelepiped-shaped, with connector 7 placed on one of its sides for setting into the socket 5 (FIG. 1) of the microcomputer housing and to connect the cartridge's software application to be run under the operating system of the microcomputer 1.

The electrical connection and the arrangement of the pins on the socket may be designed according to any known specification for connecting a cartridge to a microcomputer.

The housing of cartridge 6 (FIG. 2) includes an additional connector 8 for directly setting into it an additional cartridge. FIG. 5 shows two cartridge connected to one another. A cartridge 9 which is made as a separate module and has a separate software application is plugged into the connector socket 8 (FIG. 2) of cartridge 6. When cartridge 6 is plugged into the connector socket 5 of the microcomputer housing (FIG. 1), the software on the cartridge 9 is executed via the means of the first cartridge 6.

Electric connection of the separate software application to the microcomputer operating system via the first cartridge 6 may be made in various ways. For example, the first cartridge 6 may have in pin connectors directly connecting lower and upper pins to provide direct connection of the additional cartridge's 9 bus line to microcomputer bus. The connection also may be made via a microcircuits or units in the first cartridge 6 that form a communication unit. The unit may provide the additional cartridge and microcomputer bus connection.

The additional connector 8 (FIG. 2) is shaped like the connector socket on the microcomputer housing used for uploading the separate software application from the additional cartridge to be run under the operating system of the microcomputer.

Referring back to FIG. 5, additional cartridge 9 can be made without the additional connector 8 like the well known design. Alternatively, cartridge 9 may also include an additional connector having the same design as the embodiment of the plug 8 of the cartridge 6.

FIG. 3 shows a cartridge 6 having connectors in another embodiment of the present invention. The cartridge 6 includes three connectors 7, 8, 10, for setting three additional cartridges directly on the cartridge 6. The connectors 7, 8, 10 are shaped like the microcomputer's connector 5 (FIG. 1).

Connectors 7, 8, 10 may placed on the cartridge sides as shown in FIG. 3. Alternatively, one or more connectors may be placed on the face of the cartridge. FIG. 4 illustrates a cartridge having a connector placed on the face side of it. A connector 40 is placed on the lateral face of the cartridge 6.

In one embodiment, setting connectors on the side face of the cartridge housing provides serial or serial-star architecture of cartridge connection to the minicomputer 1. Cartridge shown in FIG. 4 provides serial-spatial architecture of cartridge connection to the minicomputer 1. FIG. 7 illustrates an example of an embodiment where two cartridges are connected to a microcomputer. In this example, the cartridges 6, 9 are joined horizontally. Additional cartridges may be joined vertically as shown in FIG. 5. These examples are given for a minicomputer with plane of the connector socket 5 placed on the same direction as the view of the screen. Consequently, the shape of the device with set cartridges is L-type configuration.

If the socket is placed on a housing side with the plane of the connector socket 5 parallel to the housing plane from the direction of the screen, the device will have plane (smooth) layout when cartridges are set. FIG. 11 shows the configuration where the connector socket 5 is placed on the side of the microcomputer's housing.

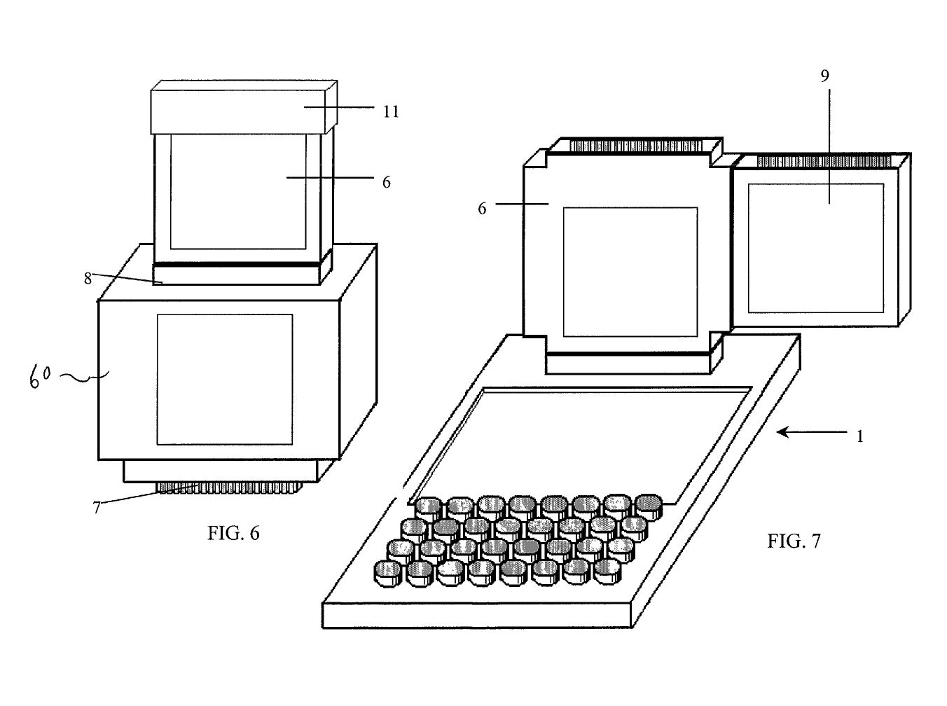

Idle connectors of the cartridges may be covered with a lid 11 as shown in FIG. 6. Additional connector of the cartridges may be made with opening leafs, e.g., like in “Dandy” television-game device.

The cartridges 6, 9 may include any type of software applications. Examples of cartridges that may be connected include but are not limited to, game cartridges, radio-modems, net radio-boards, video cameras, expanded memory, text and graphics editors, dictionaries, radio-transceivers etc . . .

Accordingly, with the portable computer device of the present invention, more than one cartridge may be set on a pocket device and run simultaneously. A number of the cartridges joined and therefore accessed via the microcomputer at one time can be increased by equipping cartridges with additional connectors 8 of the same shape and embodiment as connector socket 5.

For example, housings of all the cartridges can be of the same thickness as it is shown in FIG. 5. That is, cartridges may have the same dimensions in height, width and length. In another embodiment, cartridge housings may be made to have a different thickness as shown in FIG. 6. For example, a housing of at least one cartridge 60 may be made with dimensions in height, width and length of the housing different from those of at least one of other cartridges 6.

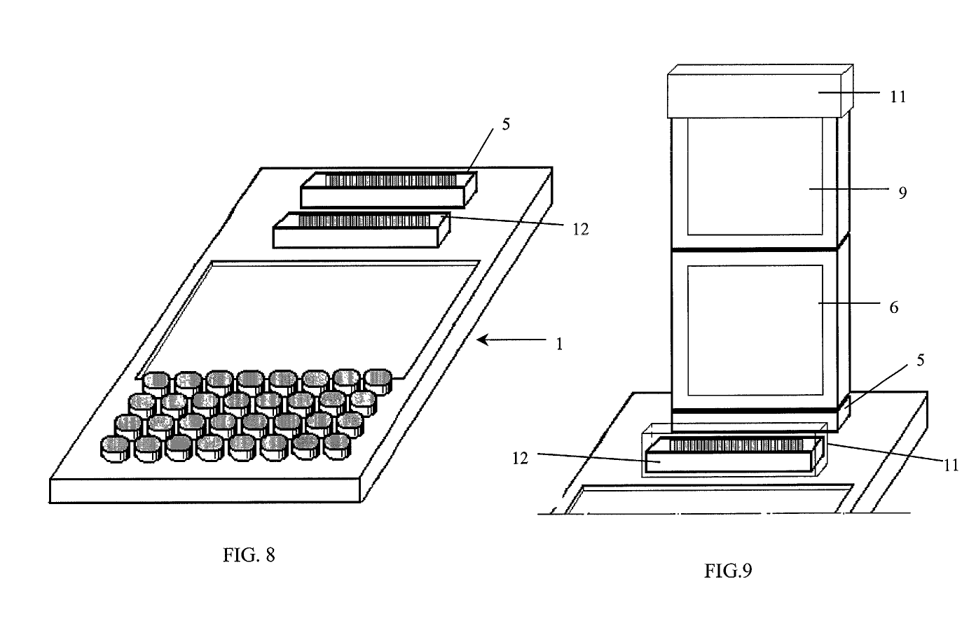

FIG. 8 shows a micro or minicomputer of the present invention in another embodiment. The housing 1 includes at least one additional connector 12 for directly setting and electrically connecting an additional software cartridge. To be compatible with the microcomputer and other cartridges, the cartridge set into the socket 12 is made similar to those considered above.

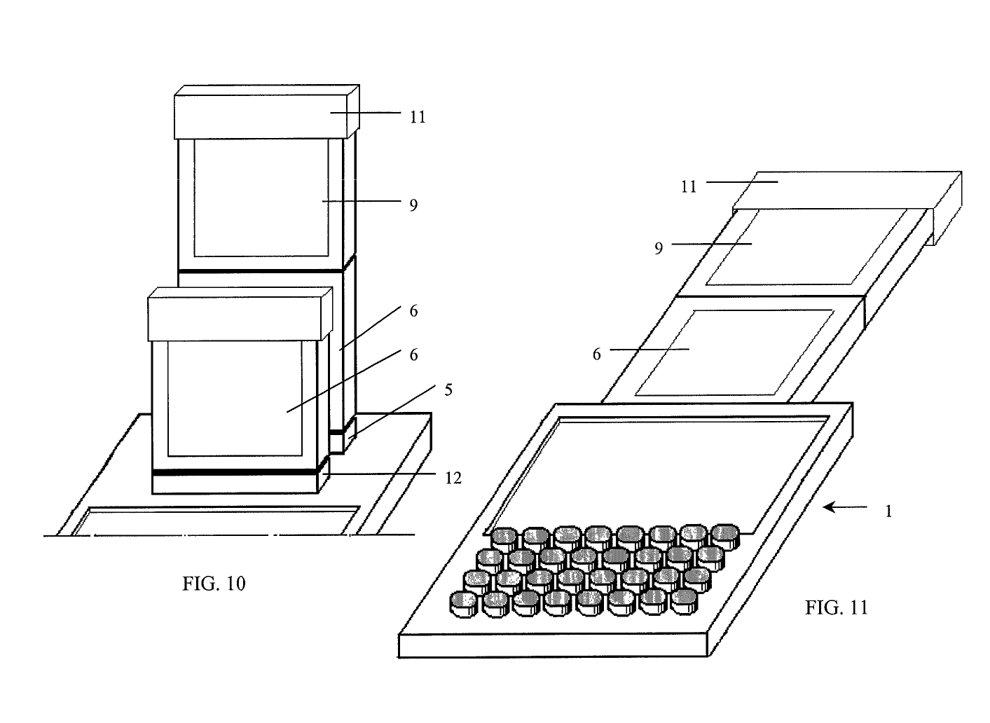

This design of microcomputer or minicomputer 1 makes it possible to set either one cartridge or a block of cartridges to the same connector socket as shown in FIG. 9. A lid 11 may be placed on the second socket 12. Alternatively, cartridges may be set into two sockets 5 and 12 simultaneously as shown in FIG. 10. With these configurations of the device of the present invention, the maximum computing power of the minicomputer can be utilized.

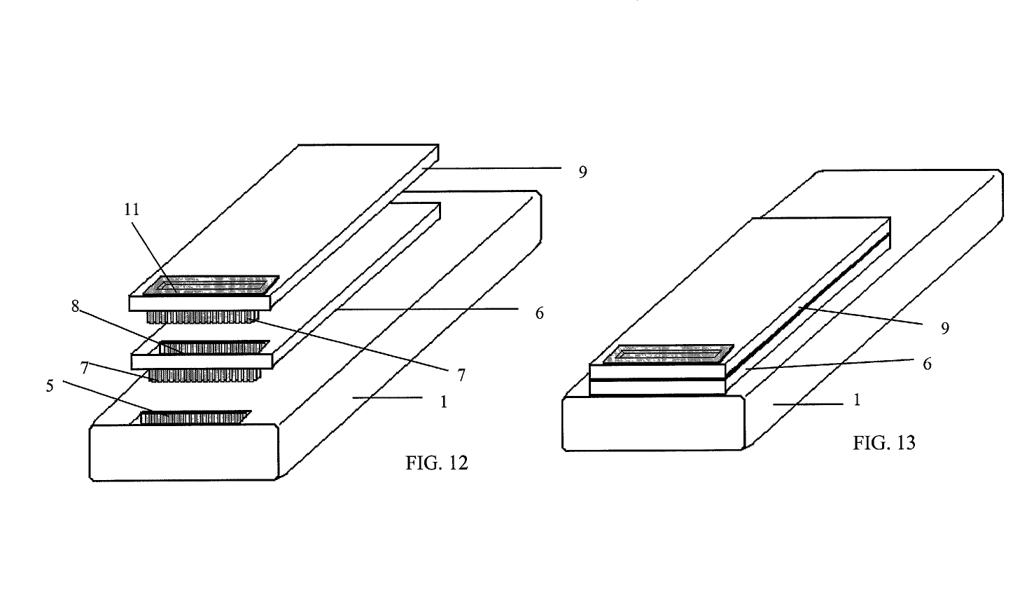

FIGS. 12 and 13 show additional embodiments of the device of the present invention. In FIGS. 12 and 13, the microcomputer or minicomputer 1 is made in the form of a parallelepiped-shaped block. The minicomputer 1 has a connector socket 5 on the back side. A cartridge is connected to the connector socket 5 by placing the cartridge 6 flat on the back surface of the micro or minicomputer 1.

In addition, the cartridge 6 may have an additional connector 8 on its surface opposite the side placed flat on the minicomputer 1. Connector socket 5 on the microcomputer or minicomputer 1 is placed on the back side (relatively to the screen and keypad side) in such a way that the plane of its socket lies athwart a housing side plane. The second plane cartridge 9 of the same embodiment as the first cartridge 6 is set to the additional connector of the first cartridge and placed on the flat surface of this cartridge. The cartridges can differ in thickness as well as in other overall parameters. Idle connectors of such flat cartridges can be covered with lids 11. FIG. 13 illustrates the components of FIG. 12 set on the minicomputer 1.

The present invention is commercially applicable as it relates to module architecture and configuration of portable pocket computer device that allows to realize several separate tasks in serial or parallel mode via using modern electronic technology used for computer devices design.

While the invention has been particularly shown and described with respect to a preferred embodiment thereof, it will be understood by those skilled in the art that the foregoing and other changes in form and details may be made therein without departing from the spirit and scope of the invention. For example, connectors in different configurations as well as cartridges of different shapes may be included.

We claim:

1. A portable computer device, comprising:
a microcomputer having a connector socket for directly connecting a cartridge to the microcomputer;
a cartridge having a plurality of connector sockets, at least one of the plurality for connecting the cartridge to the microcomputer, and at least another one of the plurality for connecting the cartridge to an additional cartridge,
wherein the microcomputer can execute instructions on the cartridge and the additional cartridge without having to disconnect the cartridge and the additional cartridge.

2. The device of claim 1, wherein the microcomputer includes at least one additional connector socket for directly connecting an additional cartridge with the microcomputer.

3. The device of claim 1, wherein the cartridge includes another additional connector for directly connecting the additional cartridge.

4. The device of claim 1, wherein the connector socket of the cartridge is placed on its side and the additional cartridge when connected is perpendicular to the cartridge.

5. The device of claim 1, wherein the cartridge and the additional cartridge have equal thickness.

6. The device of claim 1, wherein the cartridge and the additional cartridge have different thickness.

7. The device of claim 1, wherein the cartridge and the additional cartridge have the same dimensions in height, width, and length.

8. The device of claim 1, wherein the cartridge and the additional cartridge have different dimensions in any one or more of height, width, and length.

9. The device of claim 1, wherein the microcomputer further includes a screen and a keypad with at least control keys.
